(19) United States
(12) Patent Application Publication
(10) Pub. No.: US 2016/0288757 A1
(43) Pub. Date: Oct. 6, 2016

(54) KNEE-PROTECTING AIRBAG DEVICE

(71) Applicant: TOYODA GOSEI CO., LTD., Kiyosu-shi (JP)

(72) Inventor: Takeshi ANDO, Kiyosu-shi (JP)

(21) Appl. No.: 15/045,306

(22) Filed: Feb. 17, 2016

(30) Foreign Application Priority Data
Mar. 31, 2015 (JP) 2015-71681

(51) Int. Cl. B60R 21/206; B60R 21/231

(52) U.S. Cl. CPC B60R 21/206; B60R 21/231; B60R 2021/161

(57) ABSTRACT

An airbag of a knee-protecting airbag device is mounted on a case together with an inflator with the aid of mounting means of the inflator. The airbag includes a vehicle body side panel, an occupant side panel, a mounting inflatable region which is located in a lower end region of the airbag as deployed and is secured to the case, and a knee-protecting region. The airbag further includes a tether which is joined to the occupant side panel in the mounting inflatable region of the airbag by the lower end inside the airbag for preventing a sagging movement of the vehicle body side panel in a region of the mounting inflatable region distant from the inflator in a left and right direction at airbag deployment.

### CROSS REFERENCE TO RELATED APPLICATIONS

The present application claims priority from Japanese Patent Application No. 2015-071681 of Ando, filed on Mar. 31, 2015, the entire disclosure of which is incorporated herein by reference.

### BACKGROUND OF THE INVENTION

1. Field of the Invention

The present invention relates to a knee-protecting airbag device which includes an airbag, an inflator for feeding the airbag with an inflation gas and a generally box-shaped case for housing the airbag and inflator and which case includes an airbag emergence opening at the bottom end region.

2. Description of Related Art

JP2013-119327A discloses a known knee-protecting airbag device which includes an airbag, an inflator and a case for housing the airbag and inflator. The case includes an airbag emergence opening at the bottom end region, and the airbag and inflator are mounted on the case with the aid of a mounting bolt.

In the known airbag device, the airbag is mounted on the case by its mounting inflatable region with the aid of the inflator. The airbag emergence opening is configured to be openable downward. The inflator is located to one side in a left and right direction inside the case in such a manner as to extend along the left and right direction. This configuration provides a void space inside the case between the inflator and the side of the case at which the inflator is not disposed. Further, the region of the mounting inflatable region of the airbag not supported by the inflator is likely to be inflated in a sagging fashion at airbag deployment. In order to prevent this phenomenon, the known airbag device is provided, on an outside of the mounting inflatable region of the airbag, with a tether that is mounted on the case by the opposite ends with a separate mounting means and located inside the case for covering the underside of the mounting inflatable region of the airbag and regulating the outer contour of the airbag at airbag deployment.

However, since the tether is provided separate from the airbag on the outside of the airbag and mounted on the case with the separate mounting means, this configuration has a room for improvement in simplification.

### SUMMARY OF THE INVENTION

An object of the present invention is to provide a knee-protecting airbag device which is capable of deploying an airbag quickly while controlling the contour of the airbag as deployed with a simple configuration. The knee-protecting airbag device of the invention is mountable on a vehicle and includes an airbag, an inflator for feeding an inflation gas to the airbag and a case for housing the airbag and inflator. The case is provided with an airbag emergence opening at the lower end region. The inflator is generally cylindrical in outer contour and is mounted on the case with the aid of a mounting means in such a manner as to extend generally along a left and right direction.

The airbag is mounted on the case in a folded-up configuration with the aid of the mounting means together with the inflator and includes:

a vehicle body side panel deployable towards a vehicle body structure;

an occupant side panel deployable towards a seat of the vehicle;

a mounting inflatable region that is located in a lower end region of the airbag as deployed and is secured to the case;

a knee-protecting region that is deployable in such a manner as to extend rearwardly and upwardly from the mounting inflatable region for protecting knees of a vehicle occupant; and

a tether configured to prevent a sagging movement of the vehicle body side panel in a region of the mounting inflatable region distant from the inflator in a left and right direction at airbag deployment.

The lower end region of the tether is joined to the occupant side panel in the mounting inflatable region inside the airbag.

With the knee-protecting airbag device of the invention, although the inflator is located to one side in a left and right direction of the case together with the airbag, the tether disposed inside the airbag will prevent the vehicle body side panel of the region of the mounting inflatable region which is distant from the inflator in a left and right direction from sagging during airbag deployment. Moreover, since the lower end of the tether is joined to the occupant side panel inside the mounting inflatable region, the tether will prevent the region of the mounting inflatable region distant from the inflator from being droopy and thus help inflate the airbag quickly in a generally balanced fashion in a left and right direction during airbag deployment with a simpler configuration in comparison with conventional knee-protecting airbag devices.

Therefore, the knee-protecting airbag device of the invention will be capable of deploying the airbag quickly while controlling the deployed contour of the airbag with a simple configuration.

In the knee-protecting airbag device of the invention, it is desired that an upper end region of the tether is supported by the inflator directly or indirectly at airbag deployment. This configuration will prevent the upper end region of the tether from moving downward in a steady fashion, and prevent the vehicle body side panel from moving downward in an adequate fashion.

More particularly, it is desired that the upper end region of the tether is brought into contact with the inflator and supported by the inflator at airbag deployment. It is further desired that the mounting means supports the upper end region of the tether at airbag deployment.

In the knee-protecting airbag device of the invention, the tether may be so disposed as to be deployable in front of the inflator. Alternatively, the tether may also be disposed so as to be deployable at the rear of the inflator.

Moreover, in the knee-protecting airbag device of the invention described above, it is desired that:

the tether is formed into a band deployable generally along a left and right direction at airbag deployment; and

a first end in a width direction of the tether is joined to the vehicle body side panel generally entirely while a second end in the width direction of the tether is joined to the occupant side panel generally entirely, such that the tether is disposed over a generally entire area in a left and right direction of the mounting inflatable region.

This configuration will prevent an entire area in a left and right direction of the vehicle body side panel of the region distant from the inflator in a left and right direction from deploying downward at airbag deployment and help inflate the airbag quickly in a balanced fashion in a left and right direction.

In the knee-protecting airbag device of the invention, it is desired that:

the tether is formed into a band deployable generally along a left and right direction at the rear of the inflator at airbag deployment;

a first end in a width direction of the tether is joined to the vehicle body side panel generally entirely while a second end in the width direction of the tether is joined to the occupant side panel generally entirely, such that the tether is disposed over a generally entire area in a left and right direction of the mounting inflatable region; and

a region of the airbag defined by the mounting inflatable region and the tether is inflatable into a rod shape extending generally in a left and right direction in an initial stage of airbag deployment.

If, with this configuration, the region of the mounting inflatable region located in front of the tether is entirely inflated into a rod shape extending in a left and right direction including the region distant from the inflator in a left and right direction in an initial stage of airbag deployment, a region of the airbag in a vicinity of the inflator including the vehicle body side panel will be prevented from moving downward in an initial stage of airbag deployment in a secure fashion, and the airbag will be inflated in a balanced fashion quickly.

### BRIEF DESCRIPTION OF DRAWINGS

FIG. 1 is a schematic vertical section of a knee-protecting airbag device embodying the invention as mounted on a vehicle, taken along a front and rear direction of the vehicle;

FIG. 2 is a schematic enlarged vertical section of the airbag device of FIG. 1 taken along a left and right direction of the vehicle and viewed from the front side of the vehicle;

FIG. 3 is a rear view of an airbag for use in the airbag device of FIG. 1 as unfolded and flattened;

FIG. 4 is a front view of the airbag of FIG. 3;

FIG. 5 is a schematic vertical section taken along line V-V of FIG. 3;

FIG. 6 is a partial enlarged view of FIG. 5 showing a mounting inflatable region;

FIG. 7 is a schematic partial enlarged vertical section taken along line VII-VII of FIG. 4;

FIG. 8 depicts a base cloth for forming a tether and the tether formed by folding the base cloth in half, by plan views;

FIG. 9 depicts base members for forming the airbag of FIG. 3 by plan views;

FIG. 10 depicts base cloths for forming various tethers disposed inside the airbag of FIG. 3 by plan views;

FIG. 11 is a schematic vertical section of the airbag device of FIG. 1 taken along a front and rear direction as the airbag is fully deployed;

FIG. 12 is a partial enlarged view of FIG. 11 showing the mounting inflatable region;

FIG. 13 is a schematic vertical section of the airbag device of FIG. 1 taken along a left and right direction in a vicinity of the mounting inflatable region and viewed from the rear of the vehicle, as the airbag is fully deployed;

FIG. 14 is a schematic vertical section of a modification of the airbag as fully deployed, taken along a front and rear direction at a mounting inflatable region;

FIG. 15 is a schematic vertical section of another modification of the airbag as fully deployed, taken along a front and rear direction at a mounting inflatable region;

FIG. 16 is a schematic vertical section of yet another modification of the airbag as fully deployed, taken along a front and rear direction at a mounting inflatable region;

FIG. 17 is a schematic vertical section of yet another modification of the airbag as fully deployed, taken along a front and rear direction at a mounting inflatable region;

FIG. 18 is a schematic vertical section of yet another modification of the airbag as fully deployed, taken along a front and rear direction at a mounting inflatable region;

FIG. 19 is a schematic vertical section of the airbag of FIG. 18 as fully deployed, taken along a left and right direction of the vehicle at the mounting inflatable region; and

FIG. 20 is a schematic vertical section of yet another modification of the airbag as fully deployed, taken along a left and right direction of the vehicle in a vicinity of the mounting inflatable region and viewed from the rear of the vehicle.

### DESCRIPTION OF PREFERRED EMBODIMENTS

Preferred embodiments of the present invention are described below with reference to the accompanying drawings. However, the invention is not limited to the embodiments disclosed herein. All modifications within the appended claims and equivalents relative thereto are intended to be encompassed in the scope of the claims.

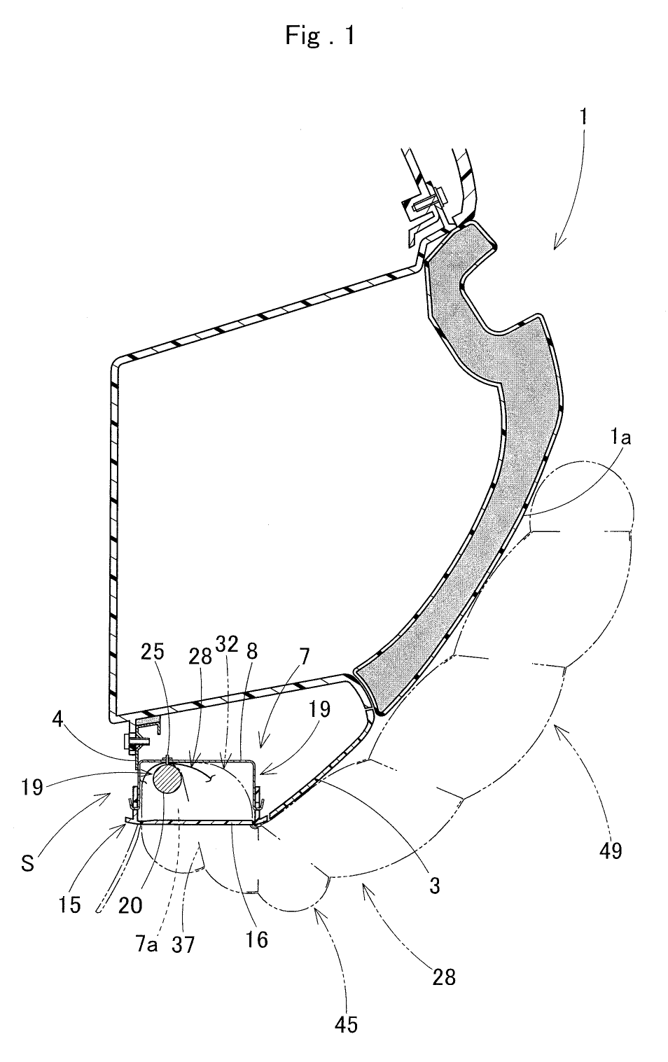

In this specification, a preferred embodiment will be described as applied to a knee-protecting airbag device S mountable in front of a front passenger seat, as shown in FIG. 1.

The knee-protecting airbag device S is located beneath the glove box 1 in front of the front passenger seat. Unless otherwise specified, up/down, left/right and front/rear directions in this specification are intended to refer to up/down, left/right and front/rear directions of a vehicle equipped with the airbag device S.

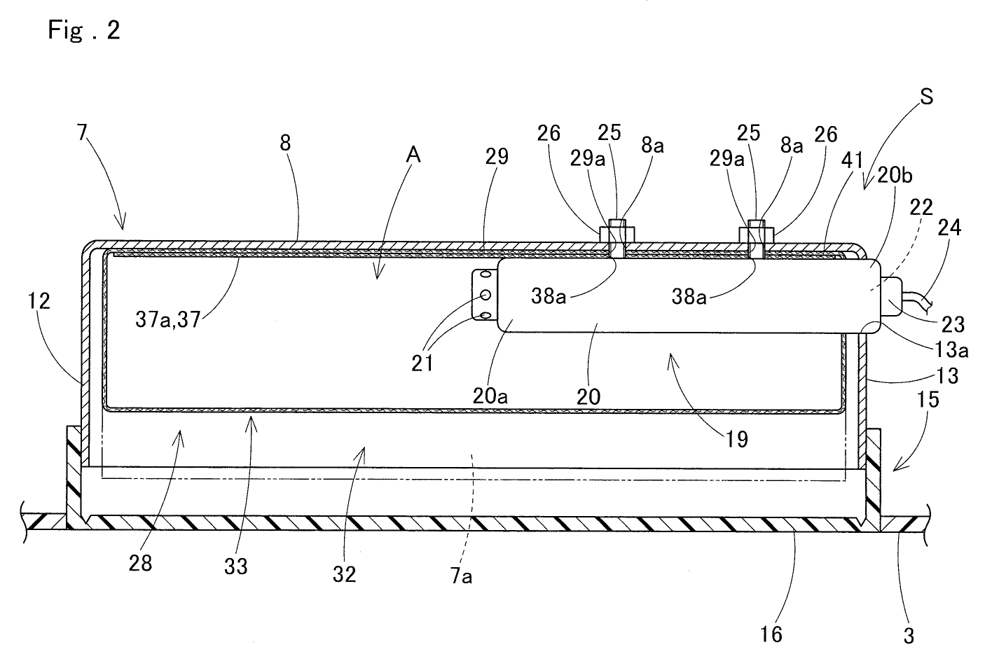

As shown in FIGS. 1 and 2, the airbag device S includes an airbag 28, which is in a folded-up configuration, an inflator 19 for feeding the airbag 28 with an inflation gas, a case 7 for housing the airbag 28 and inflator 19 and an airbag cover 15 for covering an airbag emergence opening 7a of the case 7.

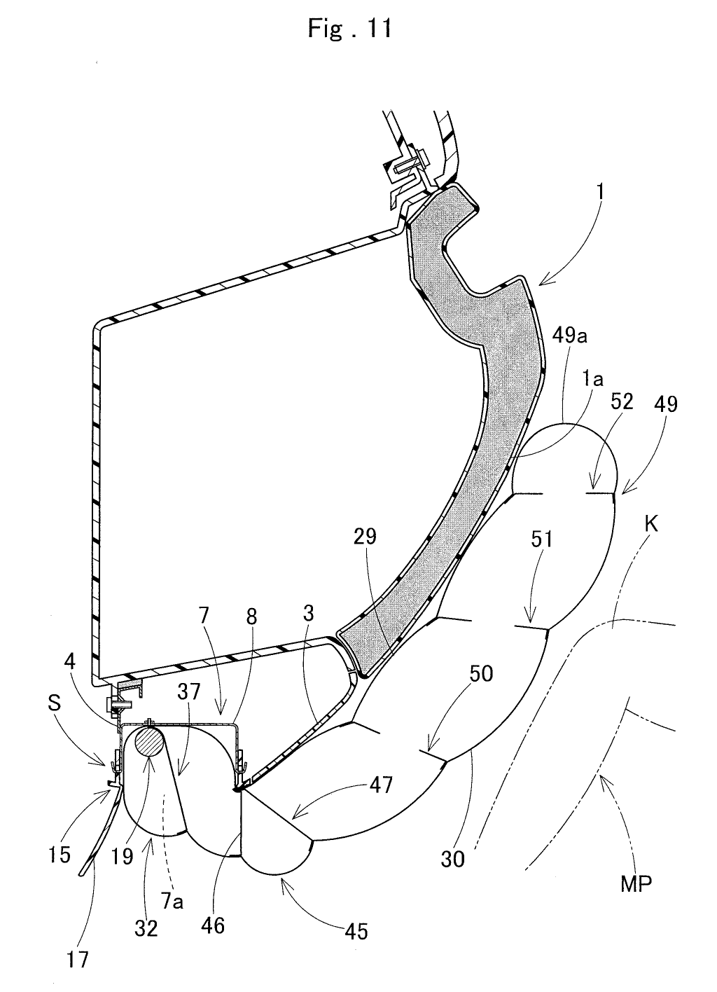

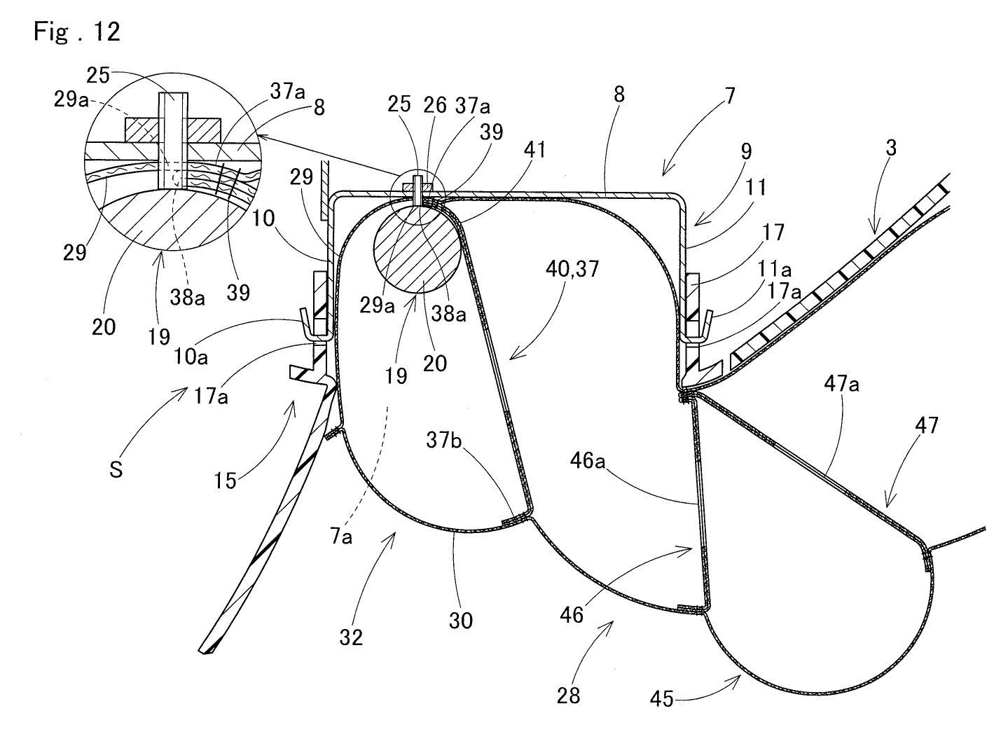

As shown in FIGS. 1 and 2, the case 7 is located on the underside of the glove box 1 so as to be located in front of and below knees K of a passenger MP as a vehicle occupant. The case 7 is made of sheet metal and is formed into a generally box. The airbag emergence opening 7a, out of which the airbag 28 emerges at deployment, is located at the bottom end region of the case 7 (FIG. 11). Specifically, the case 7 includes a generally square tubular circumferential wall 9 and a ceiling wall 8 that is formed into a rectangular plate and closes off the top of the circumferential wall 9. The lower end region of the circumferential wall 9 serves as the airbag emergence opening 7a. The circumferential wall 9 is so designed that its length direction extends generally in a left and right direction and its axial direction extends generally along an up and down direction. As shown in FIGS. 2 and 12, the ceiling wall 8 is provided, proximate the front end, two mounting holes 8a for receiving mounting bolts (serving as mounting means) 25 of the inflator 19. As shown in FIG. 12, the circumferential wall 9 is provided, on each of the front wall 10 and rear wall 11 opposing in a front and direction, with a plurality of hooks 10a and 11a engageable with peripheral edges of later-described retaining holes 17a of the side wall 17 of the airbag cover 15. The hooks 10a and 11a are arranged along a left and right direction of the front wall 10 and rear wall 11. The right wall 13 of the circumferential wall 9 includes, in a vicinity of the front end, a through hole 13a for receiving the right end 20b of the inflator 19 having a connection port 22, as shown in FIG. 2. The airbag device S of the embodiment is mounted in front of the front passenger seat of a left-hand drive vehicle although not depicted in the drawings, and therefore, the right wall 13 is disposed at an outboard side in a width direction of the vehicle. As shown in FIGS. 1 and 11, the case 7 is secured to the vehicle body structure by being connected with brackets 4 extending from the underside of the front end region of the glove box 1. Further, in the illustrated embodiment, the case 7 is covered with an undercover 3 extending in a continuous fashion from the glove box 1 by the rear side, as shown in FIGS. 1, 11 and 12. As shown in FIG. 2, the width in a left and right direction of the case 7 is about twice the length of a later-described body 20 of the inflator 19. The width in a left and right direction of the case 7 is generally identical to that of the front edge 32c of a mounting inflatable region 32 of the airbag 28 as described later.

The airbag cover 15 is fabricated of synthetic resin such as thermoplastic elastomer of polyolefin and covers the airbag emergence opening 7a of the case 7. More specifically, the airbag cover 15 includes a door 16 which covers the emergence opening 7a and is openable forward upon deployment of the airbag 28, and a side wall 17 extending upward from the peripheral edge of the door 16 in such a manner as to surround the circumferential wall 9 of the case 7. Regions of the side wall 17 opposed in a front and rear direction are provided with the retaining holes 17a for receiving the hooks 10a and 11a of the case 7 to be retained by the hooks 10a and 11a, as shown in FIG. 12.

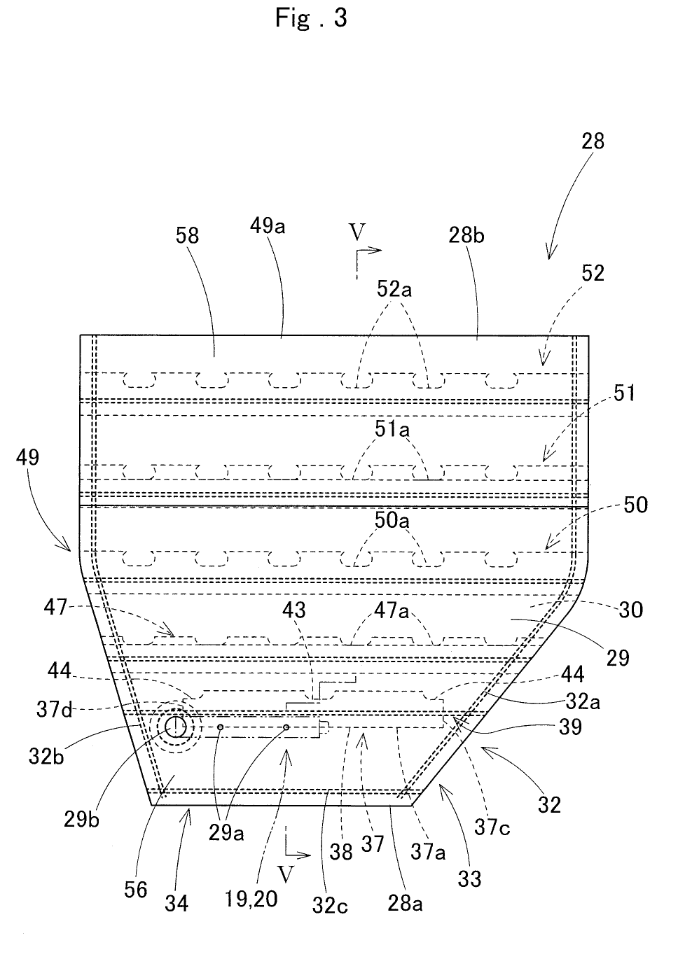

Referring to FIG. 2, the inflator 19 includes a generally cylindrical body 20 and two mounting bolts (mounting means) 25 protruding out of an outer circumference of the body 20 in a direction perpendicular to an axial direction of the inflator 19. The body 20 is provided, on the first end (or left end 20a, in the illustrated embodiment), with a plurality of gas discharge ports 21 for emitting an inflation gas, and on the second end (or right end 20b), with a connection port 22 to which a connector 23 connected with a lead wire 24 extending from an airbag actuation circuit is connected. In the illustrated embodiment, the mounting bolts 25 are arranged along the axial direction of the body 20 (i.e., along a left and right direction). The inflator 19 is housed inside the airbag 28 such that the bolts 25 protrude out of later-described mounting holes 29a of the airbag 28 and the right end 20b or connection port 22 protrudes out of a later-described insert hole 29b of the airbag 28. The length of the body 20 is so configured that the gas discharge ports 21 are located generally at the center in a left and right direction of a later-described mounting inflatable region 32 of the airbag 28 as the inflator 19 is housed inside the airbag 28, as indicated with double-dotted lines in FIG. 3. The inflator 19 thus housed in the airbag 28 is set in the case 17 such that the right end 20b or connection port 22 protrudes out of the through hole 13a of the right wall 13 of the case 7 and the mounting bolts 25 protrude out of the ceiling wall 8 of the case 7, and then the mounting bolts 25 are fastened with nuts 26. Thus the inflator 19 and airbag 28 are mounted on the case 7. As shown in FIG. 2, a large space A is formed between the left wall 12 of the case 7 and the left end 20a of the inflator 19 with the gas discharge ports 21 as secured to the case 7. In the illustrated embodiment, the right wall 13 on which the inflator 19 is mounted serves as a mount-side wall while the left wall 12 serves as a free wall, and the large space A lies between the gas discharge ports 21 and the free wall or left wall 12. The space A is generally as large as the length of the body 20 of the inflator 19. That is, the inflator 19 of the illustrated embodiment is disposed in a generally right half area of the case 7 in a vicinity of the front end (in a vicinity of the front wall 10) of the case 7.

The airbag 28 is formed of a flexible fabric woven of polyester, polyamide yarns or the like. The airbag 28 is inflatable with an inflation gas, and is designed to emerge out of the case 7 and deploy upward between the knees K of a passenger MP seated in the front passenger seat and the glove box 1. Moreover, the airbag 28 is designed to deploy along the rear plane 1a of the glove box 1 in front of the knees K of the passenger MP as shown in FIG. 1 (double-dotted lines) and FIG. 11.

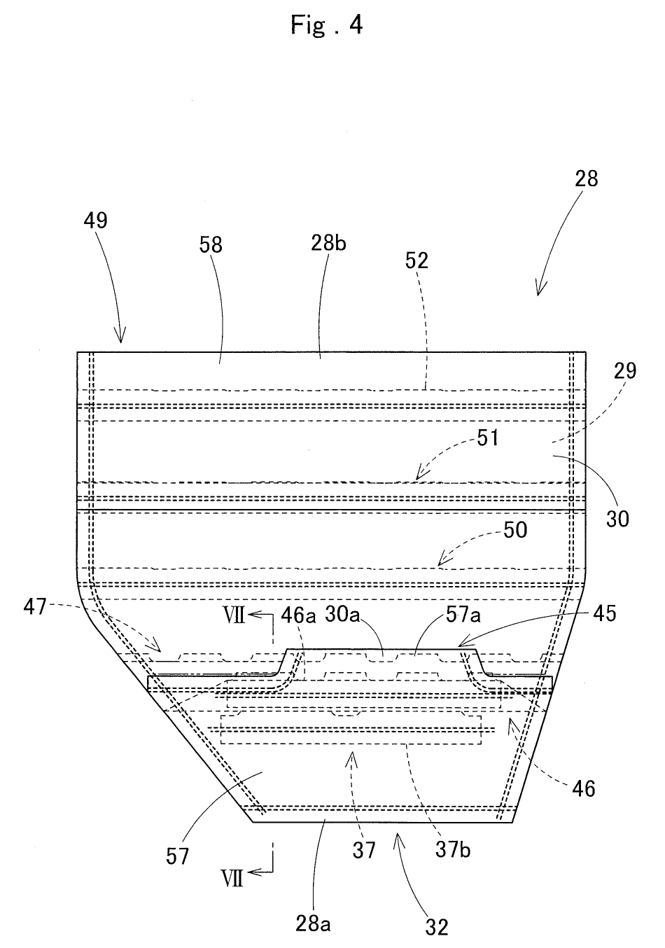

Referring to FIGS. 3, 4 and 11, the airbag 28 includes a mounting inflatable region 32 that is located at the lower end 28a region of the airbag 28 as deployed and is secured to the case 7 and a knee-protection region 49 that extends upward and rearward from the mounting inflatable region 32 for protecting knees K of the passenger MP. As shown in FIGS. 3 and 4, the knee-protection region 49 is greater in width in a left and right direction than the mounting inflatable region 32. The airbag 28, in an unfolded and flattened state, has such an outer contour that the knee-protection region 49 protrudes farther towards the left than towards the right, thus the center in a left and right direction of the knee-protection region 49 is located farther towards the left than the center in a left and right direction of the mounting inflatable region 32. The airbag 28 of the illustrated embodiment includes a pair of panels having generally identical contours; a vehicle body side panel 29 deployable towards the glove box 1 (i.e., towards the vehicle body structure) and an occupant side panel 30 deployable toward the passenger MP (FIGS. 3 to 7), and is formed into a bag by connecting (sewing) peripheral edges of the vehicle body side panel 29 and occupant side panel 30 together.

The mounting inflatable region 32 is an area inflatable inside the case 7 at airbag deployment, and is formed into a generally trapezoid tapering towards the front end 32c. The mounting inflatable region 32 includes two mounting holes 29a for receiving the mounting bolts 25 of the inflator 19 and an insert hole 29b for receiving the right end 20b of the inflator 19 on the vehicle body side panel 29, as shown in FIGS. 2 and 3. In the illustrated embodiment, the insert hole 29b is formed proximate the right edge 32b of the mounting inflatable region 32 and the mounting holes 29a are formed on the right side of the center in a left and right direction of the mounting inflatable region 32.

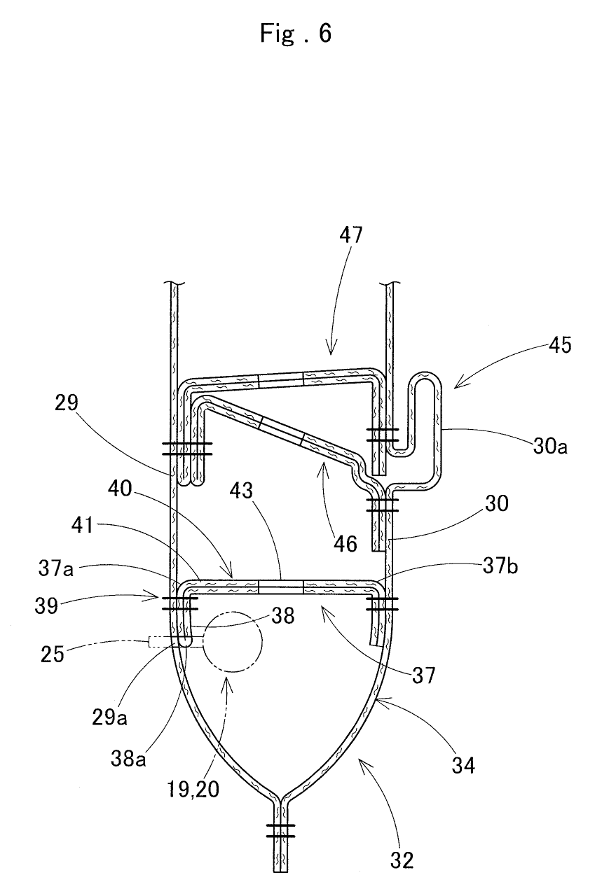

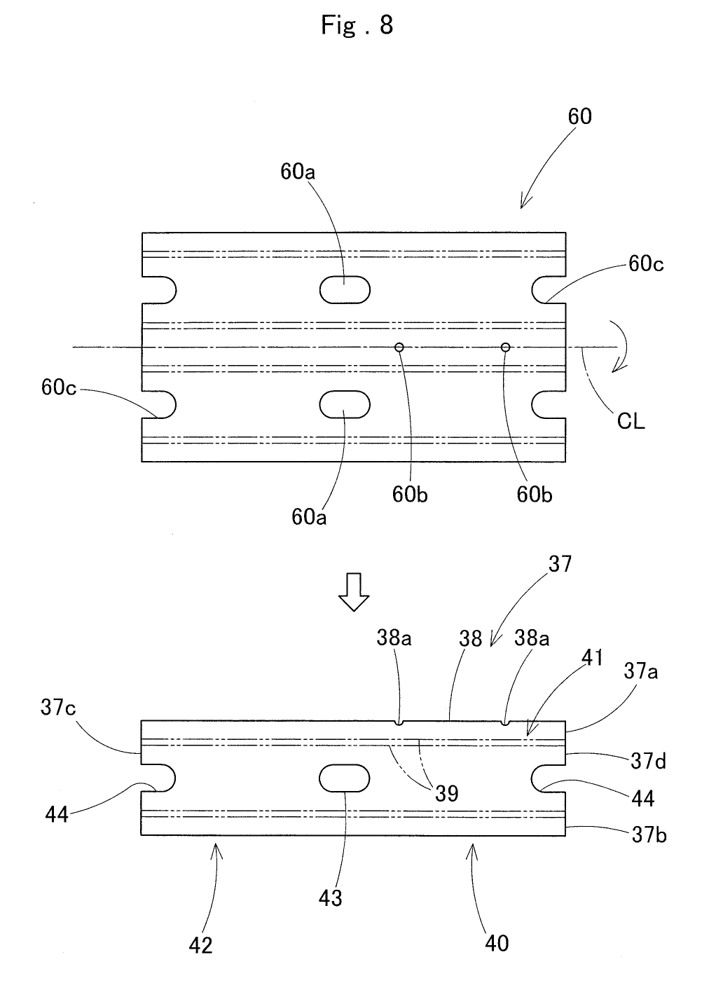

The mounting inflatable region 32 internally includes a tether 37 which is configured to prevent the vehicle body side panel 29 of a left side region (a distant region 33 which is distant from the inflator 19 in a left and right direction) of the mounting inflatable region 32 from sagging at airbag deployment. The tether 37 is formed into a band extending generally in a left and right direction. As shown in FIGS. 3 to 6, a first end in a width direction (i.e., an upper end) 37a of the tether 37 is joined to the vehicle body side panel 29 generally entirely while a second end in the width direction (i.e., a lower end) 37b of the tether 37 is joined to the occupant side panel 30 generally entirely, such that the tether 37 is disposed over a generally entire area in a left and right direction of the mounting inflatable region 32. As shown in FIGS. 11 and 12, the tether 37 is designed to be deployed in proximity to the rear of the inflator 19 at airbag deployment. More specifically, as shown in FIGS. 3 and 4, in a flattened state of the airbag 28, the right end 37d of the tether 37 is located proximate to the insert hole 29b of the vehicle body side panel 29 and the left end 37c is located in such a proximity to the left edge 32a of the mounting inflatable region 32 as to leave a small gap between the left end 37c and the left edge 32a. As shown in FIG. 12, the tether 37 is designed to be deployed generally vertically at airbag deployment. The upper end 37a of the tether 37 is sewn to the vehicle body side panel 29 over an entire area in a left and right direction with a sewing thread while the lower end 37b is sewn to the occupant side panel 30 over an entire area in a left and right direction with a sewing thread. As shown in FIG. 8, more specifically, the tether 37 is formed of a base cloth 60 in the form of a generally band. The tether 37 is formed by folding the base cloth 60 in half in a width direction on a crease CL. The base cloth 60 includes two apertures 60b for receiving the mounting bolts 25 of the inflator 19 on the crease CL. The part of the tether 37 where the crease CL is located serves as the upper end 37a and is sewn to the vehicle body side panel 29 with a seam 39. That is, as shown in FIG. 6, the tether 37 includes, at the upper edge 38 which is located farther to the end edge than the seam 39, two semicircular openings 38a disposed to match the mounting holes 29a of the vehicle body side panel 29 for receiving the mounting bolts 25.

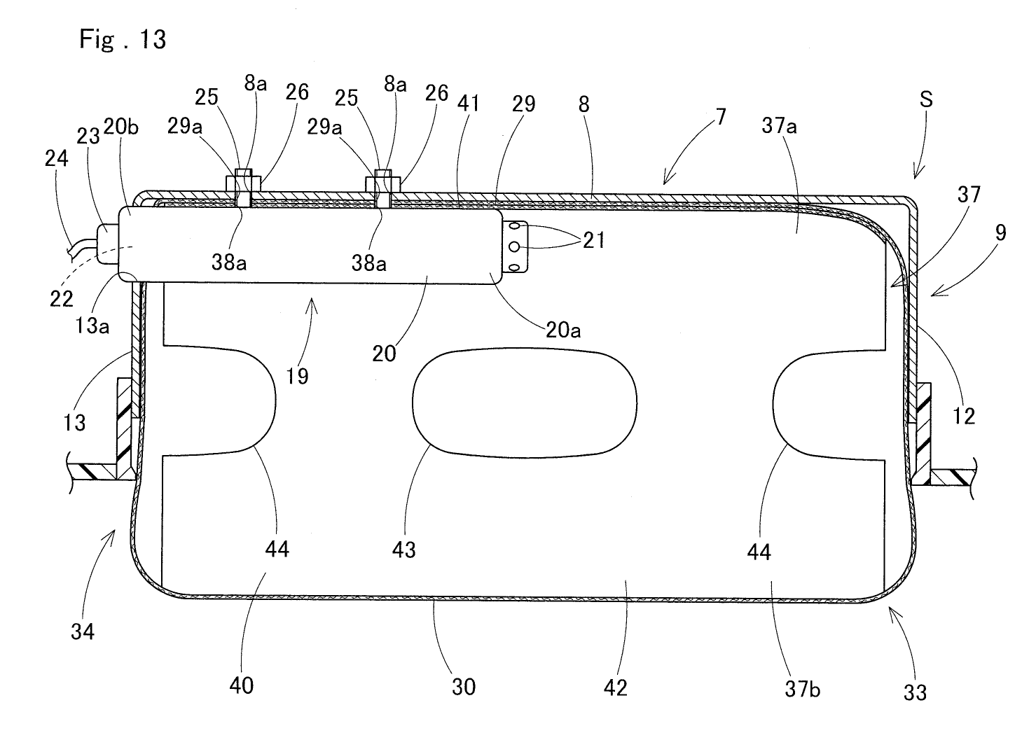

Since the mounting bolts 25 of the inflator 19 are put through the openings 38a, at airbag deployment, peripheral areas of the openings 38a will be clamped between the ceiling wall 8 of the case 7 (i.e., an inner plane of the case 7) and an outer circumference of the inflator body 20, such that the upper end 37a region (i.e., a region between the upper edge 38 and seam 39) of a right region 40 (FIG. 8) of the tether 37 where the inflator 19 is located will be brought into contact with an outer circumference of the body 20 of the inflator 19 and supported by the mounting bolts 25 as shown in FIG. 12. This region, i.e., the upper end 37a region of the right region 40 of the tether 37 will be called a supported region 41 hereinafter. Further, although the tether 37 is disposed over a generally entire area in a left and right direction of the mounting inflatable region 32, a left region 42 of the tether 37 distant from the inflator 19 will not be supported by the inflator 19 as shown in FIG. 13. Nevertheless, since the entire upper end 37a of the tether 37 is joined to the vehicle body side panel 29 by the seam 39, the upper end region of the left region 42 will also be pulled towards the inflator 19, thus the left region 42 will be prevented from moving downward at airbag deployment (FIG. 13).

As shown in FIGS. 8 and 13, the tether 37 further includes a generally oval gas communication hole 43 generally at the center in a left and right direction, and generally half oval recessed regions 44 at the left end 37c and right end 37d, both for providing gas communication. An opening area of the gas communication hole 43 and a depth of each of the recessed regions 44 (i.e., a clearance between the bottom of the recessed region 44 and the left edge 32a/right edge 32b of the mounting inflatable region 32) are so small that a front end region 34 of the mounting inflatable region 32, (i.e., a region in front of the tether 37 or a region defined by the mounting inflatable region 32 and the tether 37) will be inflated into a rod shape extending generally in a left and right direction in an initial stage of airbag deployment.

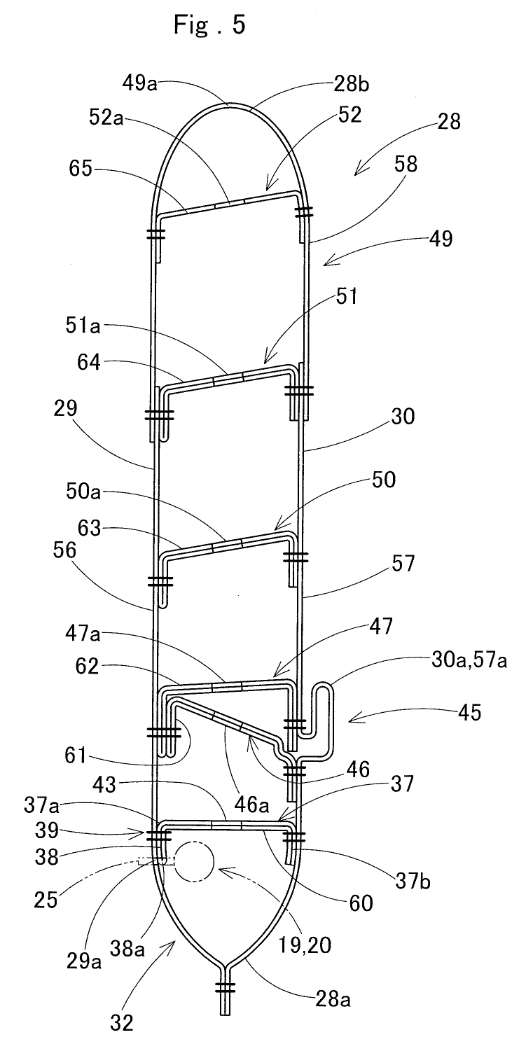

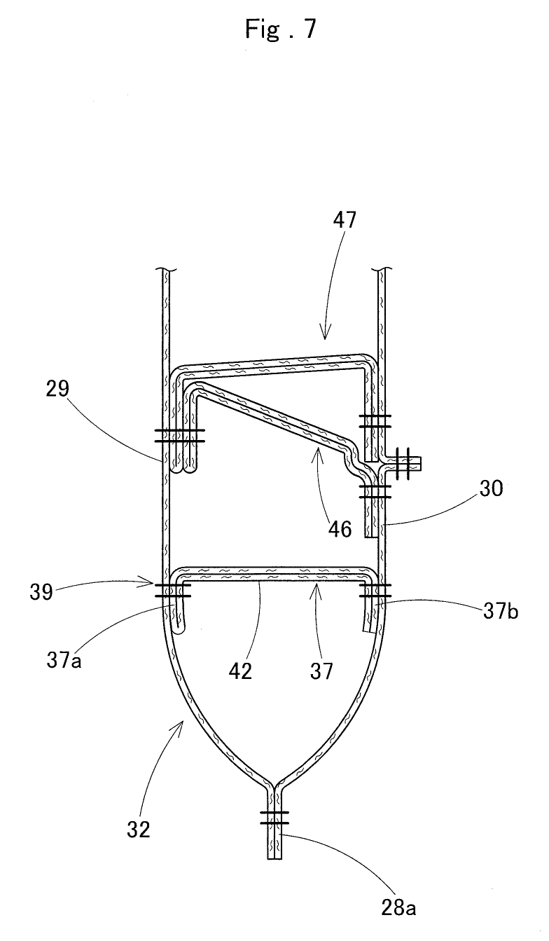

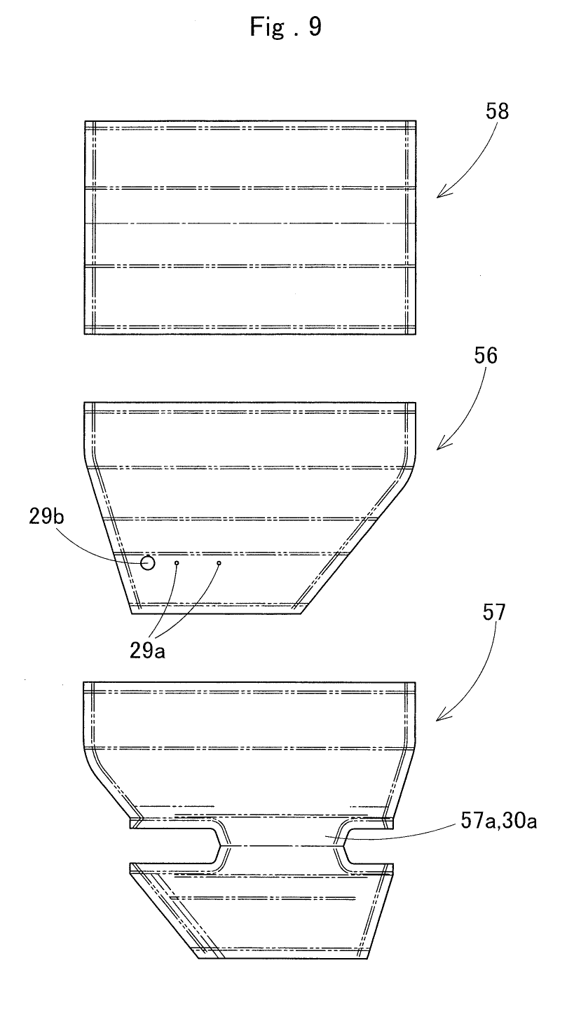

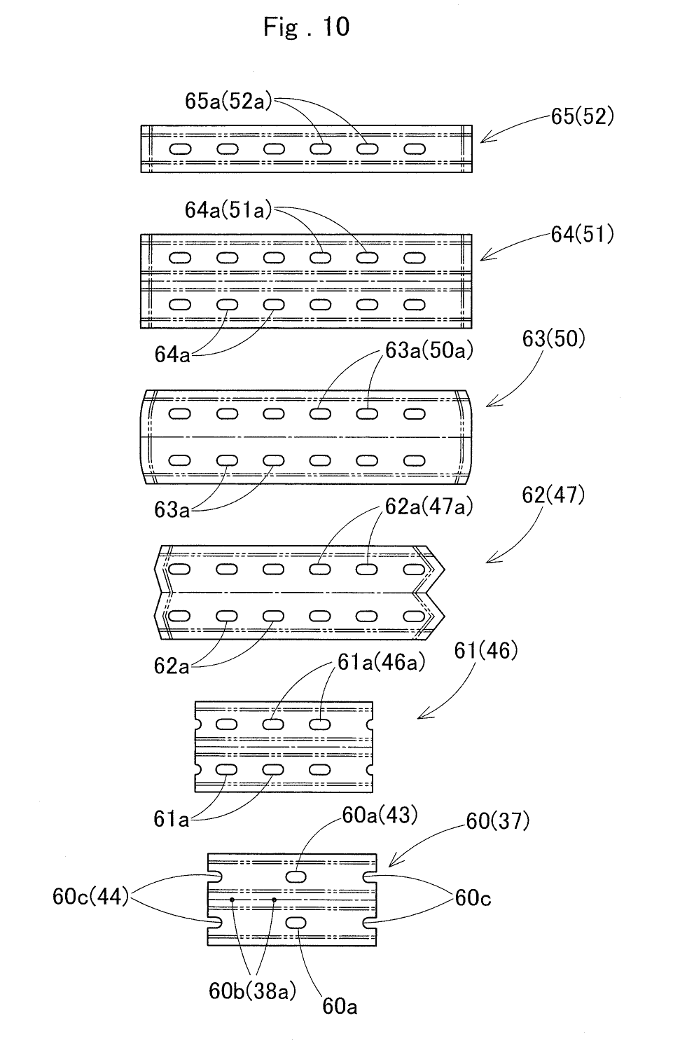

As shown in FIGS. 4, 11 and 12, the airbag 28 of the illustrated embodiment further includes an auxiliary inflatable region 45 on the occupant side panel 30 at the rear of the mounting inflatable region 32. The auxiliary inflatable region 45 is designed to be deployed at the rear and in a vicinity of the case 7 in such a manner as to protrude downward, and will serve as a point at which the airbag 28 bends upward so as to be deployed along the rear plane 1a of the glove box 1 and such that the leading end (upper end 49a) of the knee-protection region 49 is directed upward because the airbag 28 is configured to protrude once downward after emerging out of the emergence opening 7a of the case 7. More specifically, the auxiliary inflatable region 45 is formed by providing an excess region 30a in the occupant side panel 30, connecting later-described partitioning tethers 46 and 47 to the front and rear ends of the excess region 30a, tucking the excess region 30a, and joining (sewing) leading ends of the partitioning tethers 46 and 47 together to the vehicle body side panel 29 as shown in FIG. 5. In the illustrated embodiment, the width in a left and right direction of the auxiliary inflatable region 45 is smaller than the width in a left and right direction of the front edge 32c of the mounting inflatable region 32, and the auxiliary inflatable region 45 is generally trapezoidal in shape in a flattened state and protrudes partially out of the occupant side panel 30, as shown in FIG. 4. The width in a left and right direction of the partitioning tether 46, which is disposed in front of the auxiliary inflatable region 45, is generally coincident with that of the auxiliary inflatable region 45, while the partitioning tether 47, which is located at the rear of the auxiliary inflatable region 45, has a greater width in a left and right direction than the partitioning tether 46, and is disposed over a generally entire area in a left and right direction of the airbag 28. Each of the partitioning tethers 46 and 47 is formed by folding later-described base cloth 61/62 (FIG. 10) in half in a width direction. Each of the partitioning tethers 46 and 47 is provided with gas communication holes 46a/47a for providing gas communication. More particularly, the partitioning tether 46 disposed in front of the auxiliary inflatable region 45 includes three gas communication holes 46a along a left and right direction while the partitioning tether 46 located at the rear of the auxiliary inflatable region 45 includes six gas communication holes 47a along a left and right direction. In the illustrated embodiment, on the left and right sides of the auxiliary inflatable region 45, the occupant side panel 30 is formed by sewing opposing edges of a later-described base cloth 57 (FIG. 9) together directly as shown in FIG. 7.

Referring to FIGS. 3 to 5, the airbag 28 further includes inside the knee-protection region 49 three thickness regulating tethers 50, 51 and 52 each of which connects the vehicle body side panel 29 and occupant side panel 30 for regulating the thickness of the knee-protection region 49 at airbag deployment. The tethers 50, 51 and 52 are disposed one above another inside the knee-protection region 49 in such a manner as to extend along a left and right direction. In the illustrated embodiment, each of the thickness regulating tethers 50, 51 and 52 is disposed over a generally entire area in a left and right direction of the knee-protection region 49. The thickness regulating tethers 50 and 51 except the tether 52 located uppermost are each formed by folding later-described base cloths 63 and 64 (FIG. 10) in half in a width direction. Each of the thickness regulating tethers 50, 51 and 52 includes six gas communication holes 50a, 51a and 52a for providing gas communication, along a left and right direction. In the illustrated embodiment, in order that each of the thickness regulating tethers 50, 51 and 52 is deployed generally horizontally (FIG. 11), joints to the occupant side panel 30 of the tethers 50, 51 and 52 are formed on the upper side than joints to the vehicle body side panel 29 as shown in FIG. 5.

The airbag 28 is composed of a plurality of base cloths of a woven fabric of polyester, polyamide yarns or the like and cut in predetermined shapes, i.e., three base cloths 56, 57 and 58 for forming the vehicle body side panel 29 and occupant side panel 30, and six base cloths 60, 61, 62, 63, 64 and 65 for forming the tethers as shown in FIGS. 9 and 10. The airbag 28 is formed by sewing these base cloth together using sewing threads.

The base cloth 56 forms a region of the vehicle body side panel 29 from the mounting inflatable region 32 to the location of the central thickness regulating tether 51 in the knee-protection region 49 (i.e., a region of the vehicle body side panel 29 on the lower side of the tether 51), see FIG. 5. The base cloth 57 forms a region of the occupant side panel 30 from the mounting inflatable region 32 to the location of the central thickness regulating tether 51 in the knee-protection region 49 (i.e., a region of the occupant side panel 30 on the lower side of the tether 51). The base cloth 57 includes the excess region 57a(30a) for forming the auxiliary inflatable region 45 in a vicinity of the center in an up and down direction. The regions of the base cloth 57 on the left and right sides of the excess region 57a(30a) each have a split region. The base cloth 58 forms regions of the vehicle body side panel 29 and occupant side panel 30 of the knee-protection region 49 above the tether 51. Each of the base cloths 60, 61, 62, 63 and 64 is folded in half and forms the tether 37, partitioning tether 46, partitioning tether 47, the thickness regulating tether 50 and thickness regulating tether 51. The base cloth 65 forms the thickness regulating tether 52 in an unfolded state. Each of the base cloths 60, 61, 62, 63, 64 and 65 has openings 60a/61a/62a/63a/64a/65a for forming the gas communication holes 43/46a/47a/50a/51a/52a in advance. As described above, the base cloth 60 for forming the tether 37 further includes apertures 60b for forming the openings 38a for receiving the mounting bolts 25 and cut-out regions 60c for forming the recessed regions 44.

Mounting of the knee-protecting airbag device S on the vehicle is now described. Firstly, the inflator 19 is set inside the airbag 28 such that the right end 20b of the inflator body 20 (i.e., the connection port 22) protrudes out of the insert hole 29b while the mounting bolts 25 protrude out of the mounting holes 29a. At this time, the mounting bolts 25 are passed through the openings 38a of the tether 37 as well. Subsequently, the airbag 28 is folded up to fit in the case 7, and is wrapped by a tearable wrapping member (not-shown) for keeping the folded-up configuration. At this time, the mounting bolts 25 of the inflator 19 and the right end 20b of the inflator body 20 are taken out of the wrapping member.

Then the airbag 28 and the inflator 19 are set in the case 7 so the mounting bolts 25 of the inflator 19 and the right end 20b of the inflator body 20 protrude out of the mounting holes 8a and through hole 13a of the case 7. Then the mounting bolts 25 protruding out of the ceiling wall 8 of the case 7 are fastened with the nuts 26, such that the inflator 19 and airbag 28 are mounted on the case 7. At this time, the upper end 37a region of the tether 37 is clamped between the inflator body 20 and ceiling wall 8 of the case 7, thus supported by the mounting bolts 25. Thereafter, the airbag cover 15 is assembled with the case 7 by having the hooks 10a and 11a engaged with peripheral areas of the retaining holes 17a, thus completing an airbag module. This airbag module is mounted on the underside of the glove box 1 with the aid of the brackets 4. In the meantime, the connector 23 provided with a lead wire 24 extending from an airbag actuating circuit is connected with the connection port 22 of the inflator 19 protruding out of the case 7. If then the undercover 3 is mounted, the airbag device S is mounted on the vehicle.

After the airbag device S is mounted on the vehicle, if an actuating signal is fed to the inflator 19 via the lead wire 24, the inflator 19 will emit an inflation gas out of the gas discharge ports 21 into the airbag 28. Then the airbag 28 will inflate and break the wrapping member, push and open the door 16 of the airbag cover 15, and then emerge out of the emergence opening 7a of the case 7 and be deployed rearwardly and upwardly to cover the rear plane 1a of the glove box 1 as shown in FIG. 1 (by double-dashed lines) and FIG. 11, thus completing deployment.

In the knee-protecting airbag device S of the illustrated embodiment, the inflator 19 is located to one side in a left and right direction (to the right side, in the illustrated embodiment) of the case 7 as shown in FIG. 2. However, the tether 37 disposed inside the airbag 28 will prevent the vehicle body side panel 29 of the distant region 33 of the mounting inflatable region 32 which is distant from the inflator 19 in a left and right direction from sagging during airbag deployment, as shown in FIG. 13. Moreover, since the lower end 37b of the tether 37 is joined to the occupant side panel 30 inside the mounting inflatable region 32, the tether 37 will prevent the distant region 33 of the mounting inflatable region 32 from being droopy and thus help inflate the airbag 28 quickly in a generally balanced fashion in a left and right direction during airbag deployment with a simpler configuration in comparison with conventional knee-protecting airbag devices.

Therefore, the knee-protecting airbag device S of the illustrated embodiment will be capable of deploying the airbag 28 quickly while controlling the contour of the airbag 28 as deployed with a simple configuration.

The illustrated embodiment is so configured that the inflator 19 supports the upper end 37a region of the tether 37 at airbag deployment. More specifically, the mounting bolts 25 of the inflator 19 are put through the openings 38a formed at the upper edge 38a of the tether 37 such that the supported region 41 (i.e., the upper end 37a region) of the tether 37 is supported by the mounting bolts 25 while being brought into contact with the body 20 of the inflator 19 as shown in FIG. 12. That is, peripheral areas of the openings 38a of the tether 37 will be clamped between the inflator body 20 and ceiling wall 8 of the case 7. This configuration will prevent the upper end 37a region of the tether 37 (i.e., the supported region 41) from moving downward in a steady fashion, and prevent the vehicle body side panel 29 of the distant region 33 from moving downward in an adequate fashion.

Further, in the foregoing embodiment, the tether 37 is formed into a band deployable generally along a left and right direction at airbag deployment, and a first end in a width direction (i.e., the upper end) 37a of the tether 37 is joined to the vehicle body side panel 29 entirely while a second end in the width direction (i.e., the lower end) 37b of the tether 37 is joined to the occupant side panel 30 entirely, such that the tether 37 is disposed over a generally entire area in a left and right direction of the mounting inflatable region 32. This configuration will prevent an entire area in a left and right direction of the vehicle body side panel 29 of the region distant from the inflator 19 in a left and right direction (i.e., the distant region 33) from deploying downward at airbag deployment and help inflate the airbag 28 in a balanced fashion over a generally entire area in a left and right direction.

In the foregoing embodiment, the tether 37 is located at the rear of the inflator 19 at airbag deployment such that the region of the airbag 28 defined by the mounting inflatable region 32 and the tether 37 (i.e., the front end region 34 of the mounting inflatable region 32) will be inflated into a rod shape extending generally in a left and right direction in an initial stage of airbag deployment. This configuration will help inflate the front end region 34, which is located in front of the tether 37, into a rod shape extending in a left and right direction in an initial stage of airbag deployment, including the region distant from the inflator 19 in a left and right direction, and thus help prevent a region of the airbag 28 in a vicinity of the inflator 19 including the vehicle body side panel 29 from moving downward in an initial stage of airbag deployment in a secure fashion. Thus the airbag 28 will be inflated in a balanced fashion quickly. If such an advantageous effect does not have to be considered, the tether may be provided with a gas communication hole and/or recessed regions at the left and right ends with a greater opening area.

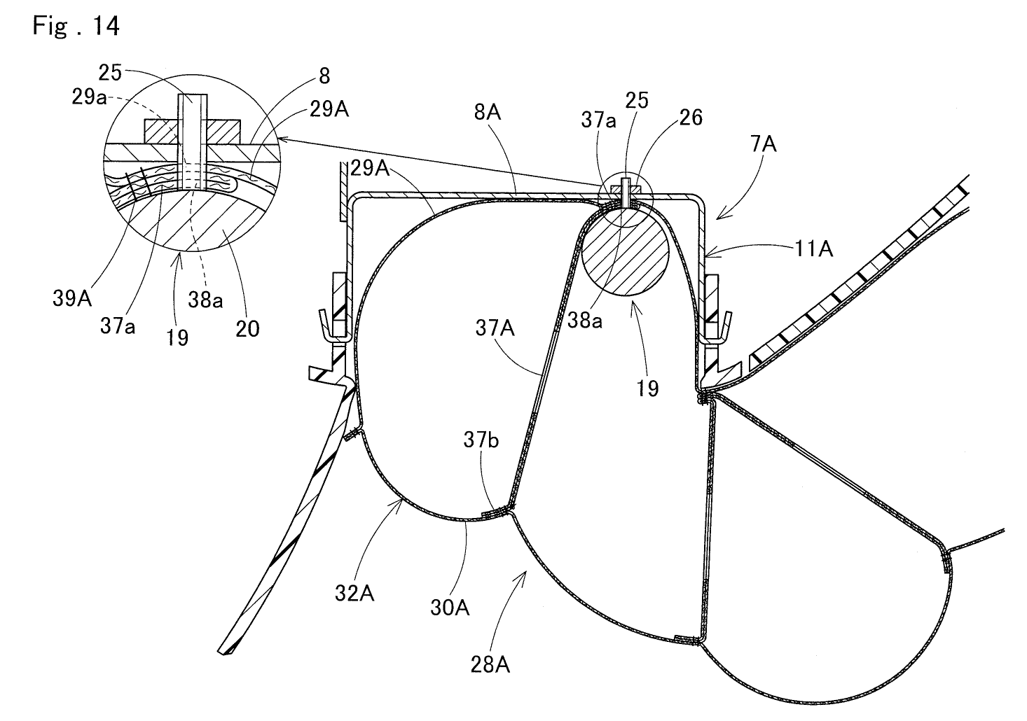

The tether 37 of the foregoing embodiment is located at the rear of the inflator 19 at airbag deployment since the inflator 19 is housed in a front end region (in a vicinity of the front wall 10) of the case 7. Alternatively, in such an instance where the inflator 19 is housed in a rear end region of a case 7A (in a vicinity of a rear wall 11A) as shown in FIG. 14, a tether 37A may be so disposed as to be deployable in front of the inflator 19. The tether 37A of the airbag 28A shown in FIG. 14 includes round openings 38a for receiving mounting bolts 25 at the upper edge such that the upper end 37a region is placed on the inflator body 20 and is supported by the inflator 19. The tether 37 of the foregoing embodiment may also be provided with generally round openings, instead of generally semicircular openings, for receiving the mounting bolts 25.

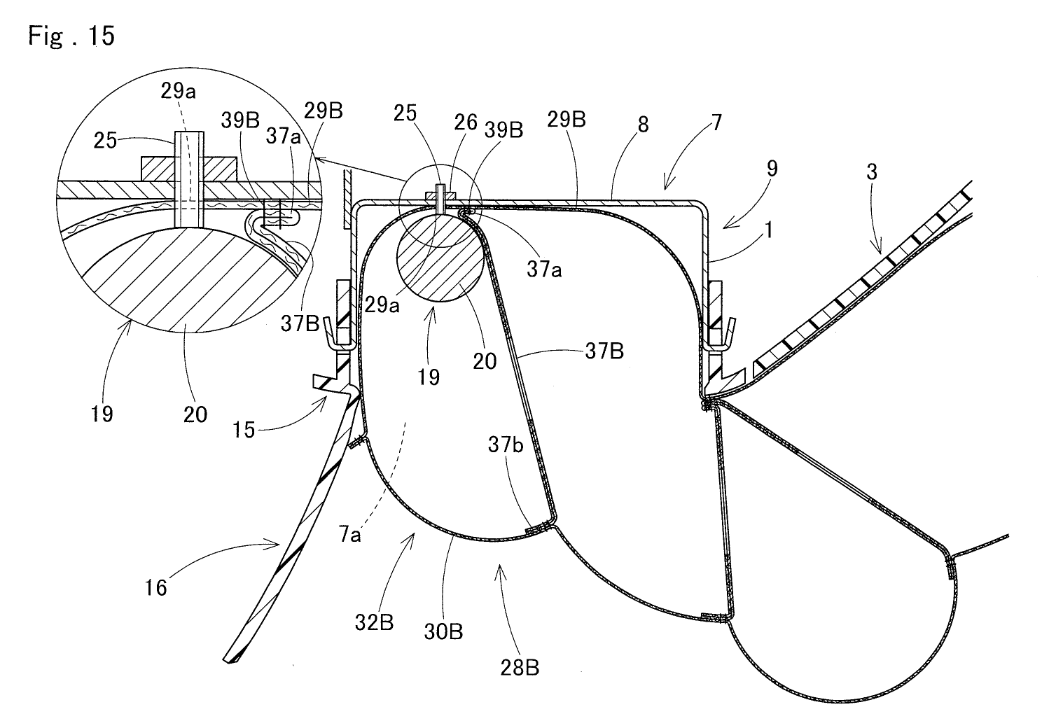

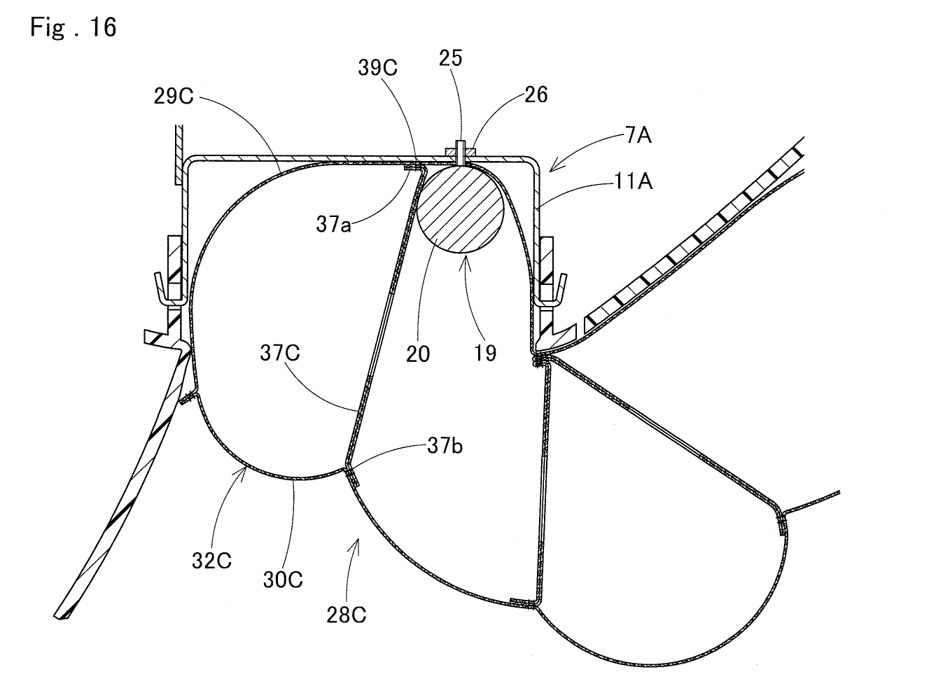

In the foregoing embodiment, the tether 37 includes the openings 38a for receiving the mounting bolts 25 such that the peripheral areas of the openings 38a are clamped between the inflator body 20 and ceiling wall 8 of the case 7 and thus supported by the inflator 19 directly. Alternatively, however, the tether may be so configured as not to let the mounting bolts pass through the tether as long as the tether is supported by the inflator. By way of example, the tether may be configured like a tether 37B shown in FIG. 15. The tether 37B is disposed at the rear of the inflator 19 inside an airbag 28B, and does not include an opening for receiving a mounting bolt. The upper end 37a region of the tether 37B is sewn to the vehicle body side panel 29B in a vicinity of and at the rear of the mounting holes 29a of the airbag 28B by a seam 39B such that the region of the tether 37B below the seam 39B is brought into contact with and supported by the inflator body 20 at airbag deployment. In an instance where the tether is located in front of the inflator 19, the tether may be configured as a tether 37C shown in FIG. 16. The tether 37C does not include an opening for receiving a mounting bolt. The upper end 37a region of the tether 37C is sewn to the vehicle body side panel 29C in a vicinity of and in front of the mounting holes 29a of the airbag 28C by a seam 39C such that the region of the tether 37C below the seam 39C is brought into contact with and supported by the inflator body 20 at airbag deployment.

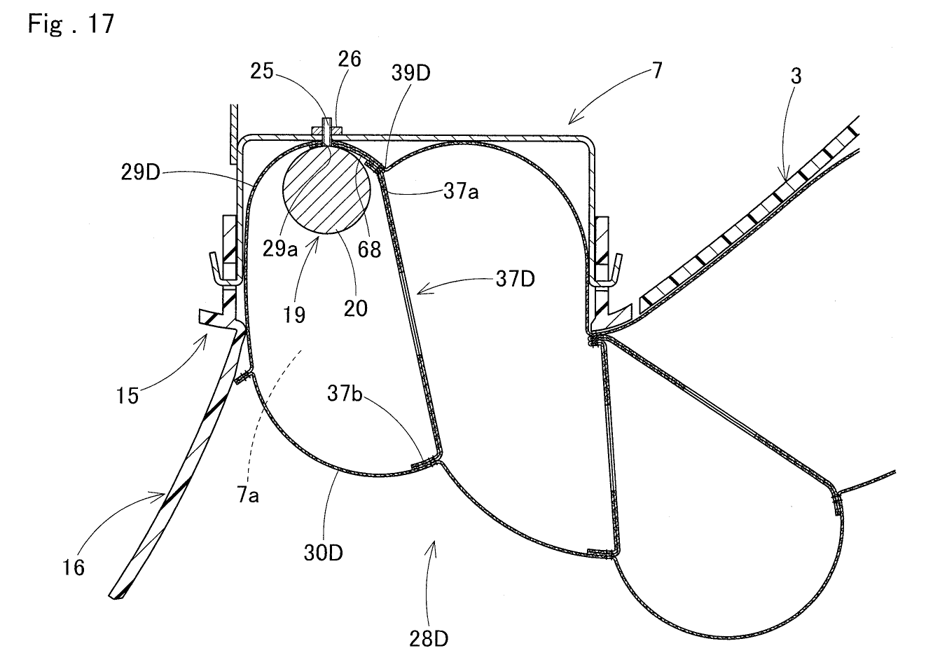

Further alternatively, the tether does not necessarily have to be supported by the inflator directly, but may be indirectly supported by the inflator. By way of example, an airbag 28D shown in FIG. 17 includes a reinforcing cloth 68 extending from a peripheral area of the mounting bolt 25, and the upper end 37a region of the tether 37D is sewn to the reinforcing cloth 68 as well as to the vehicle body side panel 29D by a seam 39D at a position distant from the inflator 19, such that the tether 37D is indirectly supported by the inflator 19 by the medium of the reinforcing cloth 68.

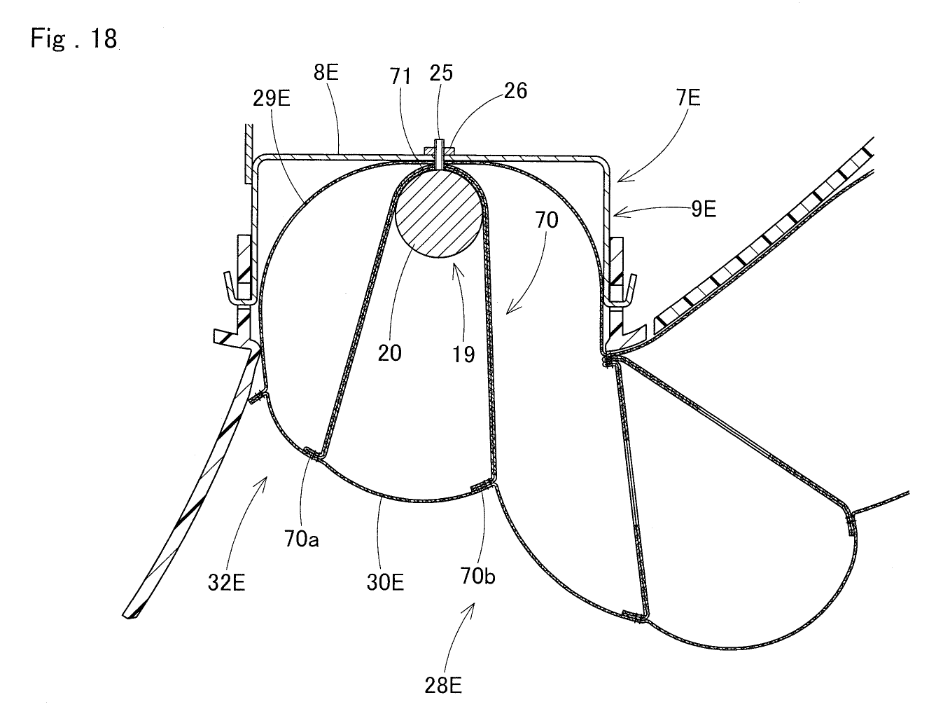

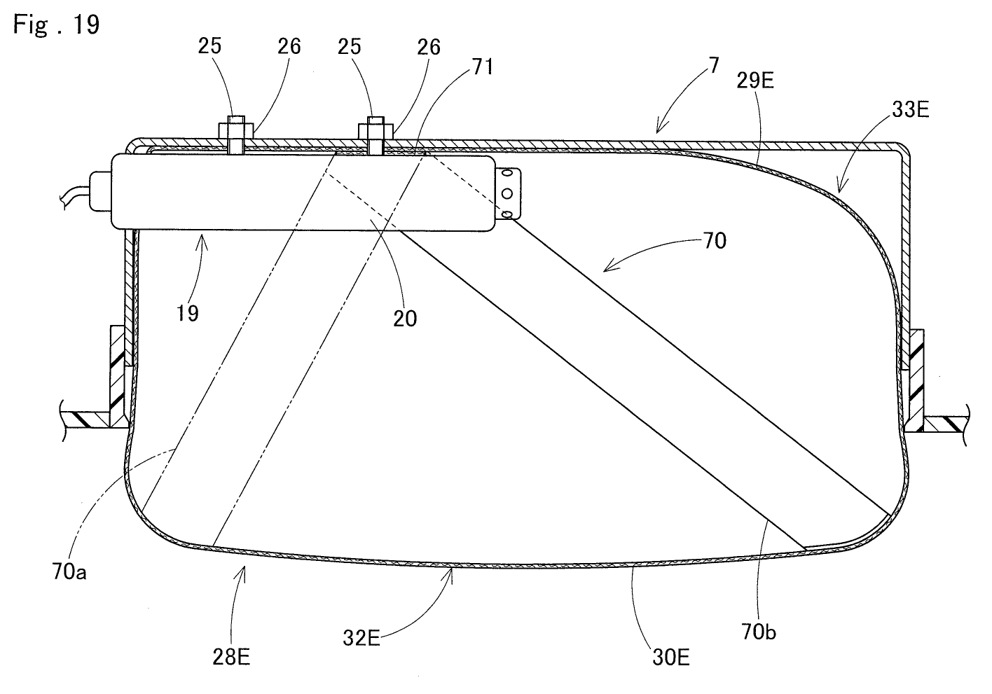

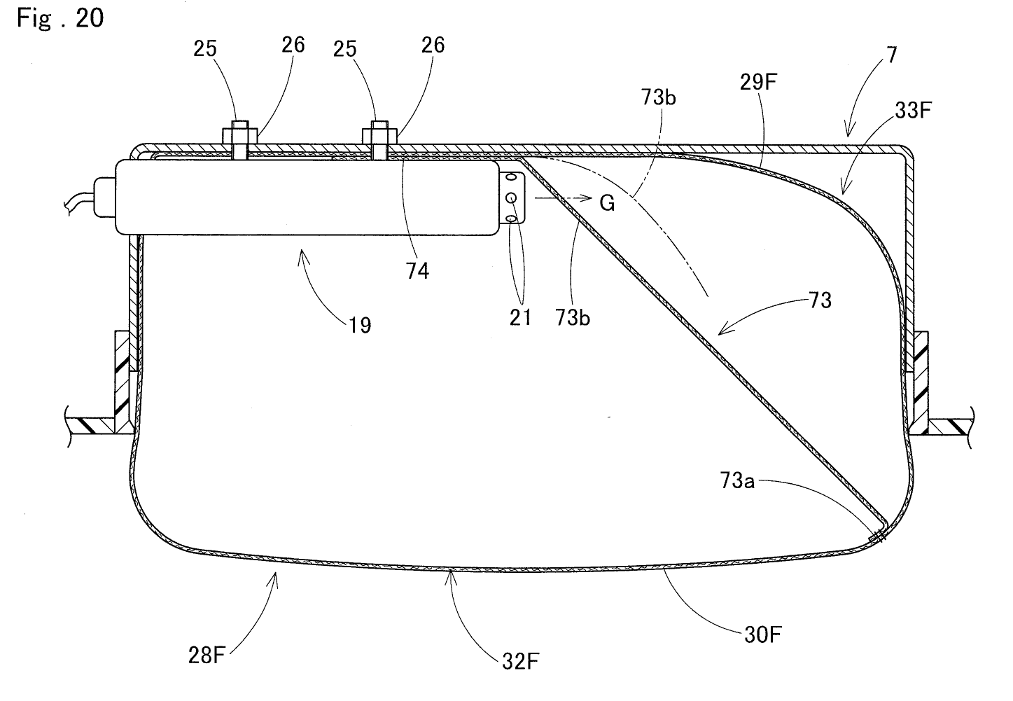

In the foregoing embodiment, the tether 37 is formed into a band deployable generally along a left and right direction at airbag deployment, and the first end in a width direction (i.e., the upper end) 37a of the tether 37 is joined to the vehicle body side panel 29 entirely while the second end in the width direction (i.e., the lower end) 37b of the tether 37 is joined to the occupant side panel 30 entirely, such that the tether 37 is disposed over a generally entire area in a left and right direction of the mounting inflatable region 32. However, the tether will work as the tether of the invention as long as it is capable of preventing a distant region of the mounting inflatable region which is distant from the inflator 19 in a left and right direction from moving downward at airbag deployment. By way of example, a knee-protecting airbag device shown in FIGS. 18 and 19 includes an inflator 19 which is housed in a vicinity of the center in a front and rear direction of a case 7E, and a band-shaped tether 70 disposed inside a mounting inflatable region 32E of an airbag 28E. The tether 70 is placed on the inflator 19 by the intermediate region, and opposite ends 70a and 70b of the tether 70 are joined to the occupant side panel 30 at positions mutually distant in four directions. More specifically, the tether 70 is mounted on the case 7E by the intermediate region (which will be called an attachment region 71 hereinafter) with the aid of mounting bolts 25 such that the attachment region 71 is clamped between the case 7E and inflator body 20 and thus supported by the inflator 19. Opposite leading end regions (i.e., the ends 70a and 70b) each extend towards the right front and left rear and are sewn to the occupant side panel 30E. FIG. 20 depicts an airbag 28F according to a further alternative embodiment. A tether 73 disposed inside a mounting inflatable region 32F of the airbag 28F includes an attachment region 74 which is mounted on the case 7 together with the inflator 19 with mounting bolts 25 and a leading end 73a region which extends towards the left (i.e., towards a distant region 33F) and is joined to an occupant side panel 30F so as to be deployable at a slant relative to an up and down direction. The tether 73 is disposed generally along a left and right direction inside the mounting inflatable region 32F such that the width direction extends along a front and rear direction. With this configuration, an intermediate region 73b of the tether 73 will be located in proximity to gas discharge ports 21 of the inflator 19 at airbag deployment, and an inflation gas G discharged out of the gas discharge ports 21 will push up the intermediate region 73b as indicated with double-dotted lines in FIG. 20, such that the tether 73 will prevent the vehicle body side panel 29F of the distant region 33F from sagging at airbag deployment in an adequate fashion.

In the foregoing embodiment, the inflator 19 has a cylindrical body 20 and the mounting bolts 25 protruding out of the body 20. However, the configuration of the inflator should not be limited thereby. By way of example, the inflator may include a separate retainer which is mounted around the body and is provided with a bolt serving as the mounting means.

Although the foregoing embodiments have been described as embodied as a knee-protecting airbag device mounted in front of a front passenger seat, the invention may also be applied to those mounted in front of a driver's seat or mounted in front of a rear seat of a vehicle.

What is claimed is:

1. A knee-protecting airbag device mountable on a vehicle, comprising:
a case provided with an airbag emergence opening at a lower end region thereof;
an inflatable airbag that is housed in and mounted on the case in a folded-up configuration, the airbag including:
a vehicle body side panel deployable towards a vehicle body structure;
an occupant side panel deployable towards a seat of the vehicle;
a mounting inflatable region that is located in a lower end region of the airbag as deployed and is secured to the case; and
a knee-protecting region that is deployable in such a manner as to extend rearwardly and upwardly from the mounting inflatable region for protecting knees of a vehicle occupant;
an inflator for feeding an inflation gas to the airbag, the inflator being generally cylindrical in outer contour and mounted on the case in such a manner as to extend generally along a left and right direction, the inflator including a mounting means for mounting the inflator and airbag on the case; and
a tether that is joined to the occupant side panel in the mounting inflatable region of the airbag by a lower end of the tether inside the airbag for preventing a sagging movement of the vehicle body side panel in a region of the mounting inflatable region distant from the inflator in a left and right direction at airbag deployment.

2. The knee-protecting airbag device according to claim 1, wherein an upper end region of the tether is supported by the inflator directly or indirectly at airbag deployment.

3. The knee-protecting airbag device according to claim 2, wherein the upper end region of the tether is brought into contact with the inflator and supported by the inflator at airbag deployment.

4. The knee-protecting airbag device according to claim 3, wherein the mounting means supports the upper end region of the tether at airbag deployment.

5. The knee-protecting airbag device according to claim 4, wherein the tether is so disposed as to be deployable in front of the inflator.

6. The knee-protecting airbag device according to claim 4, wherein the tether is so disposed as to be deployable at the rear of the inflator.

7. The knee-protecting airbag device according to claim 5, wherein:
the tether is formed into a band deployable generally along a left and right direction; and
a first end in a width direction of the tether is joined to the vehicle body side panel generally entirely while a second end in the width direction of the tether is joined to the occupant side panel generally entirely, such that the tether is disposed over a generally entire area in a left and right direction of the mounting inflatable region.

8. The knee-protecting airbag device according to claim 6, wherein:
the tether is formed into a band deployable generally along a left and right direction; and
a first end in a width direction of the tether is joined to the vehicle body side panel generally entirely while a second end in the width direction of the tether is joined to the occupant side panel generally entirely, such that the tether is disposed over a generally entire area in a left and right direction of the mounting inflatable region.

9. The knee-protecting airbag device according to claim 1, wherein:
the tether is formed into a band deployable generally along a left and right direction at the rear of the inflator;
a first end in a width direction of the tether is joined to the vehicle body side panel generally entirely while a second end in the width direction of the tether is joined to the occupant side panel generally entirely, such that the tether is disposed over a generally entire area in a left and right direction of the mounting inflatable region; and
a region of the airbag defined by the mounting inflatable region and the tether is inflatable into a rod shape extending generally in a left and right direction in an initial stage of airbag deployment.
